(19) United States
(12) Patent Application Publication
(10) Pub. No.: US 2026/0038237 A1
(43) Pub. Date: Feb. 5, 2026

(54) DEVICE AND METHOD FOR IMAGE PROCESSING

(71) Applicant: SK hynix Inc., Icheon-si (KR)

(72) Inventor: Yusuke YATA, Tokyo (JP)

(21) Appl. No.: 19/287,712

(22) Filed: Jul. 31, 2025

(30) Foreign Application Priority Data
Jul. 31, 2024 (KR) 10-2024-0102055

(51) Int. Cl. G06V 10/74; G06V 10/32

(52) U.S. Cl. CPC G06V 10/761; G06V 10/32

(57) ABSTRACT

An image processing device is provided to include a determination unit configured to i) determine, for a pixel group including pixels in an pixel array of an imaging device that receives reflected light from an object carrying a dot pattern, whether to perform an averaging processing on at least some of the pixels included in the pixel group corresponding to the dot pattern, based on a maximum amplitude value, and ii) determine target pixels from among the pixels, based on a result of summing at least some of the amplitude values of pixel signals of the pixels in the pixel group; and a calculation unit in communication with the determination unit and configured to perform an averaging processing on pixel signals of the target pixels to calculate a distance value of a distance between the imaging device and the object corresponding to the dot pattern.

### PRIORITY CLAIM AND CROSS-REFERENCE TO RELATED APPLICATION

This patent document claims the benefit of priority to Korean Patent Application No. 10-2024-0102055, filed in the Korean Intellectual Property Office on Jul. 31, 2024, the entire contents of which are incorporated herein by reference.

### TECHNICAL FIELD

The disclosure of this patent document relates to a device and a method for processing an image.

### BACKGROUND

An image sensing device is a device for capturing an optical image by using the property of a photosensitive semiconductor material which reacts to a light. With the development of automotive, medical, computer and communication industries, the demand for a high-performance image sensing device is increasing in various fields such as a smartphone, a digital camera, a game machine, an IoT (Internet of Things), a robot, a security camera, and a medical micro camera.

Nowadays, the image sensing device is actively used not only to obtain a color image but also to sense a distance to an object. This distance between the object and the image sensing device can be measured based on a time of flight (ToF) measurement which directly or indirectly measures a time taken for an emitted light pulse to arrive at an object and to then return to the image sensing device.

### SUMMARY

Some implementations of the disclosed technology have been made to solve the problems occurring in the prior art while advantages achieved by the prior art are maintained intact.

An aspect of the disclosed technology provides an image processing device which performs averaging processing on pixels corresponding to a dot pattern.

An aspect of the disclosed technology provides an image processing device which determines whether to perform averaging processing on pixels depending on whether to improve precision of the distance measurement.

An aspect of the disclosed technology provides an image processing device which performs averaging processing on at least some of pixels by determining pixels on which averaging processing will be performed.

An aspect of the disclosed technology provides an image processing device which determines whether to perform averaging processing by using a signal-to-noise ratio.

An aspect of the disclosed technology provides an image processing device which determines target pixels, on which averaging processing will be performed, by using a signal-to-noise ratio.

The technical problems to be solved by the disclosed technology are not limited to the aforementioned problems, and any other technical problems not mentioned herein will be clearly understood from the following description by those skilled in the art to which the disclosed technology pertains.

In one aspect, an image processing device may include a determination unit configured to i) determine, for a pixel group including pixels in an pixel array of an imaging device that receives reflected light from an object carrying a dot pattern, whether to perform an averaging processing on at least some of the pixels included in the pixel group corresponding to the dot pattern, based on a maximum amplitude value among amplitude values of pixel signals of the pixels, and ii) determine target pixels from among the pixels, based on a result of summing at least some of the amplitude values of pixel signals of the pixels in the pixel group; and a calculation unit in communication with the determination unit and configured to perform an averaging processing on pixel signals of the target pixels to calculate a distance value of a distance between the imaging device and the object corresponding to the dot pattern.

According to an embodiment, the determination unit may be configured to determine to perform the averaging processing, in response to the maximum amplitude value being greater than a first threshold amplitude value and smaller than a second threshold amplitude value.

According to an embodiment, the determination unit may be configured to determine the first threshold amplitude value by using a first sum amplitude value necessary to perform the averaging processing on all the pixels and a second sum amplitude value obtained by normalizing and summing the amplitude values of the pixel signals.

According to an embodiment, the determination unit may be configured to determine an amplitude value required to calculate the distance value by using one of the pixels of the pixel group, as the second threshold amplitude value.

According to an embodiment, the determination unit may be configured to determine the first threshold amplitude value and the second threshold amplitude value based on using a dark noise and a signal-to-noise ratio.

According to an embodiment, the determination unit may be configured to determine the target pixels by performing multiple summing phases summing the amplitude values one by one in descending order from maximum to minimum amplitude values and comparing a sum value calculated in each summing phase with a threshold sum value.

According to an embodiment, the determination unit may be configured to determine, as the target pixels, pixels corresponding to target amplitude values summed until the calculated sum value is greater than or equal to the threshold sum value.

According to an embodiment, the determination unit may be configured to determine all the pixels included in the pixel group as the target pixels, in response to a value obtained by adding all the amplitude values of the pixel signals included in the pixel group being smaller than the threshold sum value.

According to an embodiment, the determination unit may be configured to determine the threshold sum value so as to have different values depending on the number of the target amplitude values summed in the each summing phase.

According to an embodiment, the determination unit may be configured to determine the threshold sum value based on a dark noise and a signal-to-noise ratio.

According to an embodiment, the determination unit may be configured to further determine the pixel group such that an amplitude value of a center pixel of the pixel group is the maximum amplitude value.

According to an embodiment, the calculation unit may be configured to calculate the distance value by performing the averaging processing based on amounts of charges generated by the target pixels.

In another aspect, an image processing device may include a determination unit configured to perform summing amplitude values of pixel signals of pixels included in a pixel group of an imaging device that directs light carrying a dot pattern to an object and receives reflected light from the object, the summing of the amplitude values including multiple summing phases to sum the pixel signals one by one in descending order and to determine target pixels, on which an averaging processing is to be performed, from among the pixels based on the sum value; and a calculation unit configured to calculate a distance value of a distance between the imaging device and the object corresponding to the dot pattern by performing the averaging processing on the target pixels.

According to an embodiment, the determination unit may be configured to determine whether to perform the averaging processing on at least some of the pixels, based on a maximum amplitude value among the amplitude values, and may determine the target pixels, based on determining to perform the averaging processing.

According to an embodiment, the determination unit may be configured to determine to perform the averaging processing, in response to the maximum amplitude value being greater than a first threshold amplitude value and smaller than a second threshold amplitude value.

According to an embodiment, the determination unit may be configured to determine the first threshold amplitude value by using a first sum amplitude value to perform the averaging processing on all the pixels and a second sum amplitude value obtained by normalizing and summing the amplitude values of the signals of the pixels.

According to an embodiment, the determination unit may be configured to determine an amplitude value required to calculate the distance value by using one of the pixels of the pixel group, as the second threshold amplitude value.

According to an embodiment, the determination unit may be configured to determine, as the target pixels, pixels corresponding to target amplitude values summed until the sum value is greater than or equal to a threshold sum value.

According to an embodiment, the determination unit may be configured to determine all the pixels included in the pixel group as the target pixels, in response to a value obtained by adding all the amplitude values being smaller than the threshold sum value.

According to an aspect of the present disclosure, an image processing method may include determining target pixels, on which averaging processing is to be performed, from among pixels included in a pixel group corresponding to a dot pattern, based on a result of summing at least some of amplitude values of signals of the pixels, and calculating a distance value corresponding to the dot pattern by performing the averaging processing by using the amounts of charges generated by the determined target pixels.

The features briefly summarized above are merely example aspects of the detailed description of the disclosed technology to be described below and do not limit the scope of the disclosed technology.

### BRIEF DESCRIPTION OF THE DRAWINGS

The above and other objects, features and advantages of the disclosed technology will be more apparent from the following detailed description taken in conjunction with the accompanying drawings:

FIG. 1 is a block diagram of an imaging device based on an example embodiment of the disclosed technology.

FIG. 2 is a diagram for describing an image processing method based on an example embodiment of the disclosed technology.

FIG. 3 is a flowchart illustrating an image processing method based on an example embodiment of the disclosed technology.

FIG. 4 is a diagram for describing an image processing method based on an example embodiment of the disclosed technology.

FIG. 5 is a flowchart illustrating an image processing method based on an example embodiment of the disclosed technology.

FIG. 6 is a diagram for describing an image processing method based on an example embodiment of the disclosed technology.

FIG. 7 is a diagram for describing an image processing method according to an example embodiment of the disclosed technology.

FIG. 8 is a flowchart illustrating an image processing method based on an example embodiment of the disclosed technology.

FIG. 9 is a block diagram illustrating an example of a computing device corresponding to an image processing device of FIG. 1.

### DETAILED DESCRIPTION

Hereinafter, an embodiment of the disclosed technology will be described with reference to the accompanying drawings to such an extent as to be easily embodied by one skilled in the art. However, the disclosed technology may be implemented in several different forms and is not limited to the embodiments described herein.

In describing an embodiment of the disclosed technology, when it is determined that a detailed description of a well-known configuration or function may obscure the gist of the disclosed technology, the detailed description thereof will be omitted. Parts not related to the description of the disclosed technology are omitted in the drawings, and similar parts are denoted by similar reference numerals/signs throughout the specification.

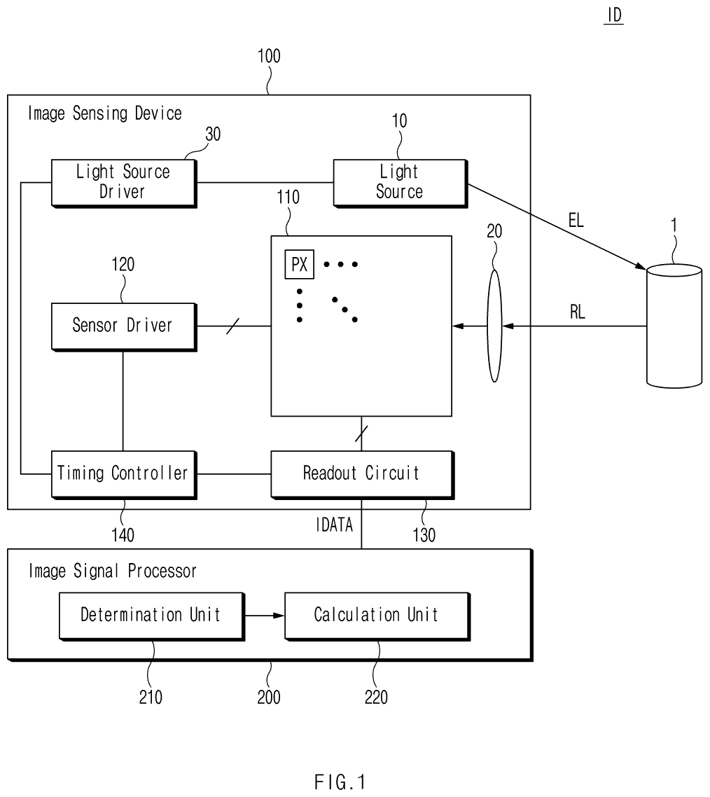

Below, example embodiments of the disclosed technology will be described in detail with reference to FIGS. 1 to 9.

FIG. 1 is a block diagram of an imaging device according to an example embodiment of the disclosed technology.

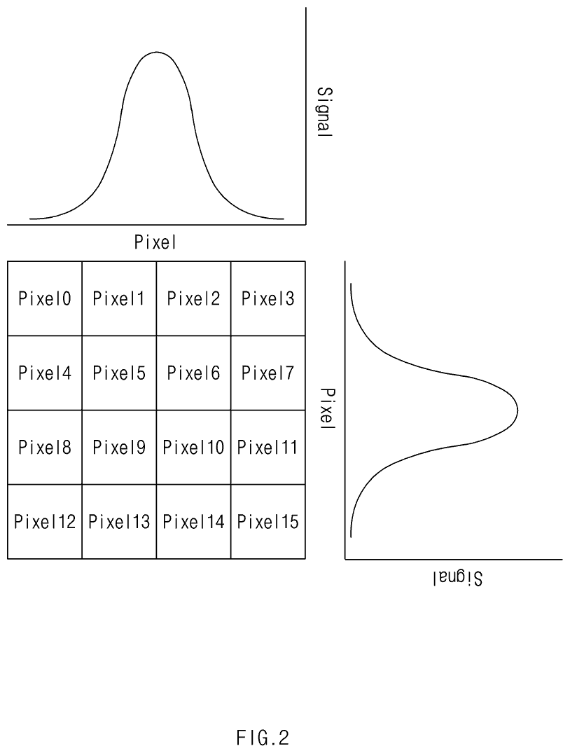

FIG. 2 is a diagram illustrating an image processing method according to an example embodiment of the disclosed technology.

Below, FIG. 1 will be described with reference to FIG. 2.

Referring to FIG. 1, an imaging device ID may mean a device such as a digital still camera, which captures a still image, a digital video camera which captures a video, etc. For example, the imaging device ID may be implemented with a digital single lens reflex (DSLR), a mirrorless camera, or a smartphone, but the disclosed technology is not limited thereto. For example, the imaging device ID may include a device which includes imaging elements and is capable of capturing a subject and generating an image. In some implementations, the imaging device ID may be a Lidar sensor.

The imaging device ID may include an image sensing device 100 and an image processing device 200.

The image sensing device 100 may be or include a complementary metal oxide semiconductor image sensor (CIS) which converts an incident light into an electrical signal. The image sensing device 100 may include a light source 10, a lens module 20, a light source driver 30, a pixel array 110, a sensor driver 120, a readout circuit 130, and a timing controller 140.

The light source 10 may emit an emitted light EL to a target object 1 in response to a modulation light signal applied from the light source driver 30. The light source 10 may be or include at least one of a laser diode (LD) emitting a light in a specific wavelength band (e.g., near-infrared rays, infrared rays, or a visible light), a light emitting diode (LED), a near infrared laser (NIR), a point light source, or a monochromatic light source in which a white lamp is combined with a monochromator, or other laser light sources. For example, the light source 10 may emit a light in an infrared wavelength band having a wavelength ranging from 800 nm to 1000 nm. In some implementations, the light emitted from the light source 10 may be a pulse light having a preset frequency, a preset period, a preset amplitude, and a preset pulse width. In FIG. 1, only a single light source 10 is illustrated for convenience of description, but a plurality of light sources may be arranged around the lens module 20.

According to an embodiment, the light source 10 may be or include a dot light source which concentrates its light emission on a plurality of points. The dot light source may can enable the irradiation of a spot light at a plurality of points by combining an optical system, such as a lens or a diffractive optical element (DOE), with a laser diode. Because the spot formed by the dot light source has a profile with a certain degree of expandability due to optical constraints, it may be emitted in the shape of spanning a plurality of pixels PX.

The lens module 20 may collect a light RL reflected from the target object 1 so as to be focused on the pixels PX of the pixel array 110. For example, the lens module 20 may include focusing lenses on a glass or plastic surface or any other cylindrical optical elements. The lens module 20 may include a plurality of lenses aligned about an optical axis.

The light source driver 30 may generate the modulation light signal MLS for driving the light source 10 under control of the timing controller 140, and in particular, may control a waveform (e.g., a frequency, a period, an amplitude, and a pulse width) of the emitted light EL output from the light source 10.

The pixel array 110 may include the plurality of pixels PX arranged continuously in a two-dimensional matrix structure (e.g., arranged continuously in a column direction and/or a row direction). Based on the control of the sensor driver 120, each of the plurality of pixels PX may sense an incident light incident through the lens module 20 to generate a pixel signal. The pixel array 110 may include a color filter array (CFA) in which color filters are arranged based on a given pattern (e.g., a Bayer pattern, a quad Bayer pattern, a Nona Bayer pattern, or an RGBW pattern) such that a light in a preset waveform band is capable of being sensed. A pattern which image data IDATA have may be defined depending on a kind of a pattern which the CFA has.

In some implementations, each pixel PX may be an infrared pixel which generates a pixel signal by sensing an incident light including the reflected light RL incident after the emitted light EL output from the light source 10 is reflected from the target object 1. For example, the infrared pixel may be a depth pixel for calculating a distance to the target object 1. In another example, the infrared pixel may include a pixel which generates an infrared image by sensing an infrared light incident simply from the scene rather than a reflected light. In some other implementations, the pixels PX may include a pixel which generates a color image by sensing a visible light incident from the scene. In the below, the description will be given based on the assumption that each pixel PX is a 2-TAP pixel for detecting a distance to the target object 1 based on an indirect ToF manner. The 2-TAP pixel may refer to a pixel structure designed for the indirect TOF (iToF) depth sensing that has two charge accumulation gates (or “taps”).

The sensor driver 120 may drive the pixels PX of the pixel array 110 in response to a timing signal output from the timing controller 140. For example, the sensor driver 120 may generate a control signal capable of selecting and controlling pixels PX included in at least one row line among a plurality of row lines of the pixel array 110.

Based on control of the timing controller 140, the readout circuit 130 may generate and store the image data IDATA for detecting the distance to the target object 1 by processing pixel signals output from the pixel array 110. The image data IDATA may be digital data obtained by performing analog-to-digital conversion on the pixel signals of an analog form. To this end, the readout circuit 130 may include a correlated double sampler (CDS) for performing correlated double sampling on the pixel signals output from the pixel array 110. Also, the readout circuit 130 may include an analog-to-digital converter for converting output signals from the correlated double sampler into digital signals. In addition, the readout circuit 130 may include a buffer memory for temporarily storing pixel data output from the analog-to-digital converter and outputting the temporarily stored pixel data to the outside under control of the timing controller 140. Meanwhile, two column lines may be provided for each column of the pixel array 110 to transfer pixel signals, and components for processing a pixel signal output from each column line may also be provided to correspond to each column line.

The timing controller 140 may generate the timing signal for controlling operations of the light source driver 30, the sensor driver 120, and the readout circuit 130. According to an embodiment, the timing controller 140 may generate the timing signal based on a given setting value and/or depending on a request of the image processing device 200. According to an embodiment, the timing controller 140 may include a logic control circuit, a phase locked loop (PLL) circuit, a timing control circuit, a communication interface circuit, etc.

The image processing device 200 may be in communication with the image sensing device 100 to receive the image data IDATA from the image sensing device 100. The image processing device 200 may generate processed image data by performing at least one image signal processing on the image data IDATA.

The image processing device 200 may reduce the noise of the image data IDATA and may perform image signal processing for improving the quality of image, such as demosaicing, defect pixel correction, gamma correction, color filter array interpolation, color matrix, color correction, color enhancement, or lens distortion correction. In some implementations, the image processing device 200 may generate an image file by performing compression processing on image data experiencing the image signal processing for improving the quality of image or may recover the image data from the image file. A compression format of an image may be a reversible format or an irreversible format. As an example of the compression format, the JPEG (Joint Photographic Experts Group) format or the JPEG 2000 format may be used for a still image. In the case of a moving image, a moving image file may be generated by compressing a plurality of frames in compliance with the MPEG (Moving Picture Experts Group) standard.

The image processing device 200 may be a computing device which is mounted on a chip independent of a chip on which the image sensing device 100 is mounted, but the disclosed technology is not limited thereto. The chip on which the image sensing device is mounted and the chip on which the image processing device 200 is mounted may communicate with each other through a given interface. According to an embodiment, the chip on which the image sensing device is mounted and the chip on which the image processing device 200 is mounted may be implemented with a single package, for example, a multi-chip package (MCP), but the scope of the disclosed technology is not limited thereto.

The image processing device 200 may include a determination unit 210 and a calculation unit 220. The determination unit 210 and the calculation unit 220 are elements of the image processing device 200 that perform the certain functions and are implemented as logical and electrical circuits/components to perform the certain functions.

The determination unit 210 may determine whether to perform averaging processing on pixels included in a pixel group corresponding to a dot pattern.

When a dot light source for concentrating an emission amount on a plurality of spots is used as a light source, the light of the dot pattern which the dot light source emits may be reflected from an object and may be incident onto pixels. The incident light of the dot pattern reflected from the object may have a profile with expandability. Accordingly, the light of the dot pattern may be emitted in the shape of spanning a plurality of pixels. For example, referring to FIG. 2, because the light of the dot pattern has a profile with expandability, the light of the dot pattern may be irradiated across a plurality of pixels, e.g., Pixel0 to Pixel15, in the shape of a dot pattern. In the example as shown in FIG. 2, the light of the dot pattern is irradiated across 16 pixels. Unlike FIG. 2, the light of the dot pattern may be irradiated across a pixel group corresponding to a dot pattern of 3×3 or 5×5 in the shape of a dot pattern, but is not limited thereto. The plurality of pixels on which the light of the dot pattern is irradiated may be referred to as a “pixel group” corresponding to the dot pattern.

A binning method being averaging processing may be used as a method of improving the precision of distance measurement by using pixels of a pixel group. In the case of performing binning, a signal component may be amplified, and a signal-to-noise ratio (S/N) may increase. This may mean that the precision of distance measurement is improved. However, because the precision of distance measurement is not improved in all the cases where averaging processing is performed, the determination unit 210 may determine whether to perform averaging processing on pixels included in a pixel group corresponding to a dot pattern. In detail, when it is possible to improve the precision of distance measurement through averaging processing, the determination unit 210 may determine to perform averaging processing for the pixel group. For example, assuming that there is performed averaging processing on two pixels (e.g., a first pixel and a second pixel), when an amplitude value of a signal of the first pixel is considerably low, the signal-to-noise ratio may not be improved even though averaging processing on the first pixel and the second pixel is performed. Even when an amplitude value of a signal of the second pixel is considerably low compared to the amplitude value of the signal of the first pixel, the signal-to-noise ratio may not be improved. Accordingly, because averaging processing is not required when the signal-to-noise ratio is not improved, the determination unit 210 according to an example embodiment of the disclosed technology may selectively perform averaging processing by determining whether to perform averaging processing.

Based on the maximum amplitude value among amplitude values of signals of pixels included in a pixel group corresponding to the dot pattern, the determination unit 210 may determine whether to perform averaging processing on at least some of the pixels.

Assuming that the image sensing device 100 emits a first modulation light and drives two taps, charges of a pixel, which are generated by a reflected light of the first modulation light, may be distributed into floating diffusion nodes of the two taps in synchronization with the driving of the two taps. In this case, charge amounts of the distributed charges may be respectively referred to as “S0” and “S180”. Also, the image sensing device 100 may emit a second modulation light obtained by shifting an emission timing of the first modulation light as much as ¼ a period; charge amounts obtained through the same method may be respectively referred to as “S90” and “S270”. An amplitude value of a signal of a pixel according to a charge amount may be determined by Equation 1 below.

$$Amplitude = \frac{\sqrt{{( S 0 - S 180 )}^{2} + {( S 90 - S 270 )}^{2}}}{2} \qquad [ Equation 1 ]$$

When the maximum amplitude value is greater than a first threshold amplitude value and is smaller than a second threshold amplitude value, the determination unit 210 may determine to perform averaging processing on at least some of pixels. The determination unit 210 may determine the first threshold amplitude value by using a first sum amplitude value necessary to perform averaging processing on all the pixels included in the pixel group and a second sum amplitude value obtained by normalizing and summing the amplitude values of the pixels of the pixel group. Also, the determination unit 210 may determine an amplitude value, which is required when a distance value is calculated by using one of the pixels of the pixel group, as the second threshold amplitude value. In addition, the determination unit 210 may determine the first threshold amplitude value and the second threshold amplitude value by using a dark noise and the signal-to-noise ratio necessary for the required precision of distance measurement. How the determination unit 210 determines whether to perform averaging processing will be described in detail later.

When the determination unit 210 determines to perform averaging processing, the determination unit 210 may perform averaging processing on at least some of the pixels of the pixel group. Also, the determination unit 210 may determine target pixels, on which averaging processing will be performed, from among the pixels of the pixel group. For example, the determination unit 210 may determine the target pixels, on which averaging processing will be performed, from among the pixels of the pixel group, based on a result of summing at least some of the amplitude values of the signals of the pixels of the pixel group. In detail, the determination unit 210 may determine the target pixels, on which averaging processing will be performed, by summing the amplitude values one by one in descending order from maximum to minimum amplitude values and comparing a sum value calculated in each summing phase with a threshold sum value. For example, the determination unit 210 may determine, as the target pixels, pixels which correspond to target amplitude values summed until the calculated sum value is greater than or equal to the threshold sum value. Also, when a value obtained by adding all the amplitude values of the signals of the pixels included in the pixel group is smaller than a threshold sum value, the determination unit 210 may determine all the pixels included in the pixel group as the target pixels. The determination unit 210 may determine the threshold sum value so as to be differently set depending on the number of target amplitude values summed in the summing phase. In addition, the determination unit 210 may determine the threshold sum value by using the dark noise and the signal-to-noise necessary for the required precision of distance measurement. Also, the determination unit 210 may determine the target pixels by determining whether an amplitude value of a signal of a pixel to be used for averaging processing is smaller than a given value. In other words, in the case of needing to sum an amplitude value smaller than the given value in the process of summing amplitude values aligned in descending order, the determination unit 210 may stop the summing process and may determine pixels participating in the summing process as the target pixels. How the determination unit 210 determines target pixels will be described in detail later.

The calculation unit 220 may calculate a distance value by performing averaging processing. In detail, the calculation unit 220 may calculate a distance value corresponding to the dot pattern by performing averaging processing on the target pixels determined by the determination unit 210. For example, the calculation unit 220 may calculate the distance value by performing averaging processing by using the amounts of charges generated by the target pixels. How the calculation unit 220 calculates a distance value will be described in detail later.

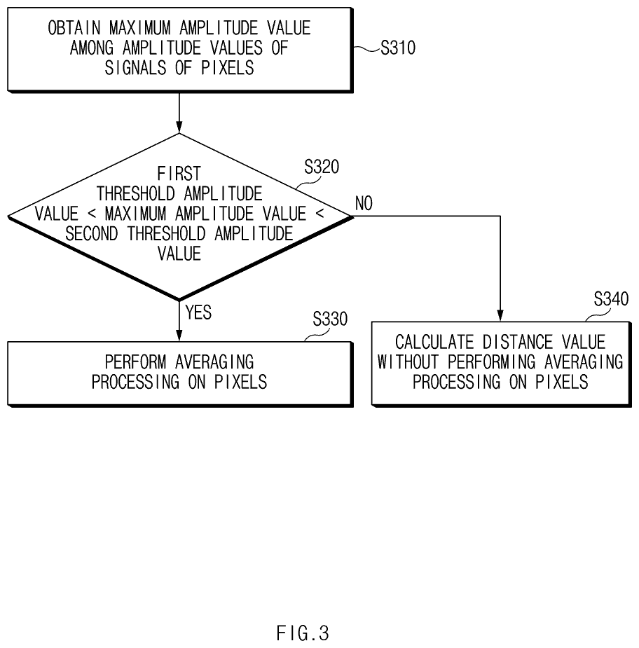

FIG. 3 is a flowchart illustrating an image processing method to according to an example embodiment of the disclosed technology.

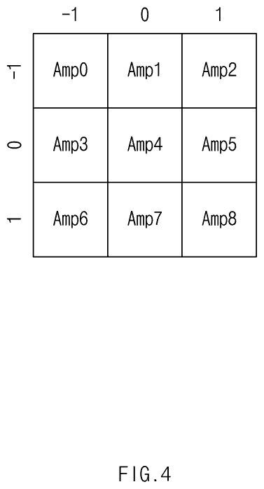

FIG. 4 is a diagram for describing an image processing method according to an example embodiment of the disclosed technology.

Below, FIG. 3 will be described with reference to FIG. 4.

Referring to FIG. 3, at S310, an image processing method according to an example embodiment of the disclosed technology may obtain the maximum amplitude value among amplitude values of pixel signals from the pixels. The image processing method may set a pixel group based on light of the dot pattern incident onto the pixels. For example, the dot size of the dot pattern is already known by a module, and thus, the image processing method may extract pixels onto which the light of the dot pattern is incident in order, for example, from the top-left of the pixels. The extracting of the pixels may proceed based on the dot size (e.g., 3×3, 4×4, or 5×5). When an amplitude value of a signal of a center pixel among the extracted pixels is the maximum value, the image processing method may set the pixels to the pixel group. For example, like FIG. 4, the image processing method may set the pixel group of 3×3, when an amplitude value Amp4 of the center pixel placed at coordinates (0, 0) may be the greatest among amplitude values Amp0 to Amp8 of pixel signals of pixels included in the pixel group. In this case, the center pixel placed at (0, 0) may be a pixel generating a signal having the maximum amplitude value. Accordingly, the image processing method may obtain the maximum amplitude value from the center pixel of the pixel group.

At S320, the image processing method may determine whether the maximum amplitude value is greater than the first threshold amplitude value and is smaller than the second threshold amplitude value. The image processing method may determine the first threshold amplitude value and the second threshold amplitude value by using the dark noise and the signal-to-noise ratio necessary for the required precision of distance measurement. When the signal-to-noise ratio necessary for the required precision of distance measurement is referred to as “S/N” and the dark noise is referred to as “N”, a sum amplitude value Str of signals of pixels necessary to perform averaging processing on “n” pixels may determine Equation below.

$$Str = \frac{S / {N}^{2} + S / N \sqrt{S / {N}^{4} + 4 {nN}^{2}}}{2} \qquad [ Equation 2 ]$$

The first threshold amplitude value may be determined by using the above sum amplitude value Str. Because the profile of the light of the dot pattern is capable of being measured in advance, the sum amplitude value Str is obtained by normalizing the amplitude values of the signals of the pixels of the pixel group, on which the light of the dot pattern is irradiated, to the maximum amplitude value and summing the normalized amplitude values. For example, when it is assumed that the pixel group is set as illustrated in FIG. 4, the sum amplitude value Str obtained by summing the normalized amplitude values may be determined by Equation 3 below.

$$Stn = \frac{{\sum }_{n = 0}^{8} {Amp}_{n}}{Amp 4} \qquad [ Equation 3 ]$$

Because Stn is a value determined in advance through measurement, the sum amplitude value Str which is necessary to perform averaging processing on all the pixels included in the pixel group may be predicted by multiplying the maximum amplitude value and Stn together. The sum amplitude value Stp which is necessary to perform averaging processing on all the pixels included in the pixel group may be determined by Equation 4 below.

$$Stp = Stn \times Amp\_dot \_c \qquad [ Equation 4 ]$$

Herein, Amp_dot_c is the maximum amplitude value. Thus, the Amp_dot_c means the amplitude value of the signal of the center pixel placed at the center of the pixel group.

The Amp_dot_c being a required maximum amplitude value may be predicted from the sum amplitude value Str necessary to perform averaging processing on all the pixels included in the pixel group corresponding to the dot pattern. When the predicted Amp_dot_c is expressed as Amp_dot_c_p, the Amp_dot_c_p may be determined by Equation 5 below.

$$Amp\_dot \_c \_p = \frac{Str}{Stn} \qquad [ Equation 5 ]$$

By adopting Amp_dot_c_p, which is determined by the above Equation 3, as a first threshold intensity value that serves as a lower limit for the maximum intensity value, the image processing method can prevent or reduce unnecessary processing, such as performing averaging processing even when the required precision of distance measurement has not been achieved.

In the implementations, because deviations in both the actual light emission and light reception optical systems may cause the light profile of the actual dot pattern to not perfectly match a profile measured in advance, the image processing method may not directly adopt the Amp_dot_c_p as the first threshold amplitude value. In some implementations, the image processing method may modify the Amp_dot_c_p and adopt a modified value as the first threshold amplitude value. For example, the image processing method may use a value smaller than the Amp_dot_c_p by a predetermined amount as the first threshold amplitude value.

As described above, the image processing method may determine the first threshold amplitude value by using the sum amplitude value necessary to perform averaging processing on all the pixels included in the pixel group and the sum amplitude value obtained by normalizing and summing the amplitude values of the signals of the pixels included in the pixel group.

As the image processing method uses the Str value corresponding to “n=1” as the second threshold amplitude value, when the maximum amplitude value is greater than the second threshold amplitude value, it may be determined that a sufficient signal-to-noise ratio is obtained with only the maximum amplitude value, even without averaging processing. Thus, the image processing method may determine an amplitude value which is required when calculating a distance value by using one pixel from the pixel group as the second threshold amplitude value.

When the maximum amplitude value is greater than the first threshold amplitude value and is smaller than the second threshold amplitude value, at S330, the image processing method may perform averaging processing on the pixels.

When the maximum amplitude value is smaller than the first threshold amplitude value or is greater than the second threshold amplitude value, at S340, the image processing method may calculate a distance value without performing averaging processing on the pixels.

The image processing method may determine that if the maximum amplitude value is smaller than the first threshold amplitude value, there is no improvement in the signal-to-noise ratio, the precision of distance measurement accuracy, etc. even though averaging is performed.

When the maximum amplitude value is greater than the second threshold amplitude value, the image processing method may not perform averaging processing as it may be possible to obtain the sufficient precision of distance measurement with only the maximum amplitude value.

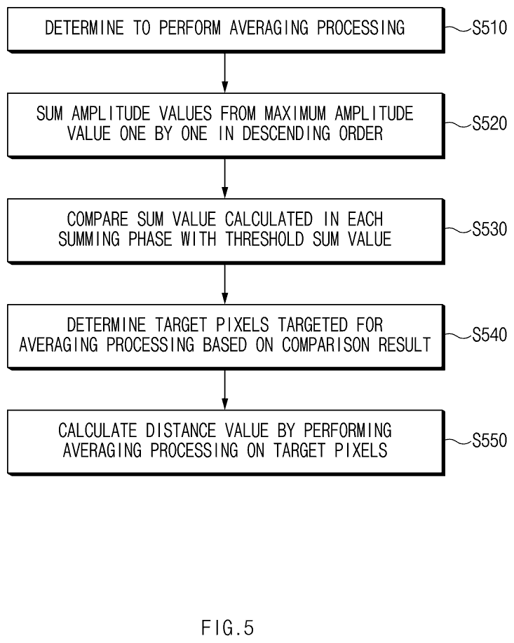

FIG. 5 is a flowchart illustrating an image processing method according to an example embodiment of the disclosed technology.

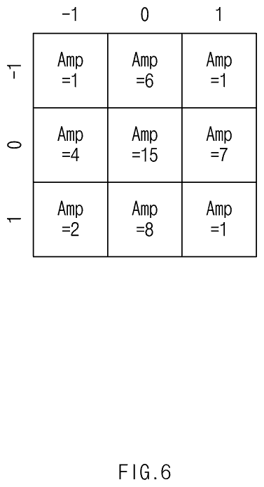

FIG. 6 is a diagram for describing an image processing method according to an example embodiment of the disclosed technology.

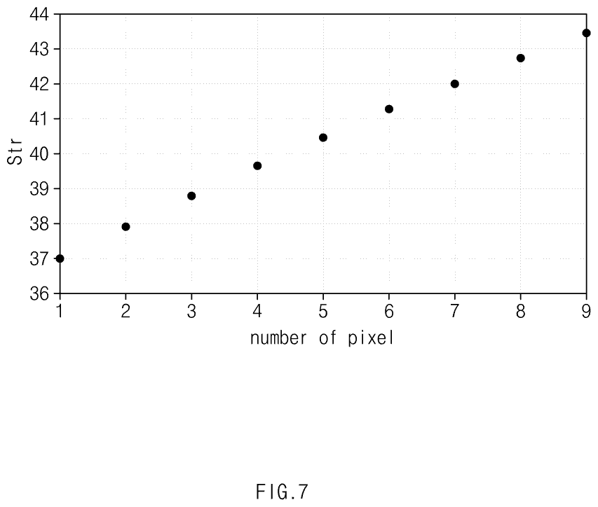

FIG. 7 is a diagram for describing an image processing method according to an example embodiment of the disclosed technology.

Below, FIG. 5 will be described with reference to FIGS. 6 and 7.

Referring to FIG. 5, at S510, an image processing method according to an example embodiment of the disclosed technology may determine to perform averaging processing. For example, based on the maximum amplitude value among amplitude values of pixel signals of pixels included in a pixel group corresponding to the dot pattern, the image processing method may determine to perform averaging processing on at least some of the pixels.

The image processing method at S520 may sum the amplitude values of the signals of the pixels included in the pixel group one by one in descending order from maximum to minimum amplitude values.

At S530, the image processing method may compare a sum value calculated in each summing phase with the threshold sum value.

At S540, the image processing method may determine target pixels on which averaging processing will be performed, based on a comparison result of comparing the calculated sum value with the threshold sum value.

In some implementation, the image processing method may determine the target pixels, on which averaging processing will be performed, by summing the amplitude values one by one in descending order from maximum to minimum amplitude values and comparing a sum value calculated in each summing phase with the threshold sum value. For example, the image processing method may determine, as the target pixels, pixels which correspond to target amplitude values summed until the calculated sum value is greater than or equal to the threshold sum value. In detail, when the sum value calculated in the first summing phase among the above summing phases is smaller than the threshold sum value, the image processing method may add an amplitude value of the next summing phase, which complies with the descending order, to the sum value. Also, when the sum value calculated in the second summing phase is smaller than the threshold sum value, the image processing method may add an amplitude value of the next summing phase, which complies with the descending order, to the sum value. In addition, when the sum value calculated in the third summing phase is greater than or equal to the threshold sum value, the image processing method may determine, as the target pixels, pixels which correspond to target amplitude values targeted for summing.

The summing of the amplitude values to determine the target pixels are described with reference to the example as shown in FIG. 6. In FIG. 6, the central pixel at coordinates (0,0) has the pixel signal with the maximum amplitude value of 15, the pixel at coordinates (1, 0) has the pixel signal with the second maximum amplitude value of 8, the pixel at coordinates (0,1) has the pixel signal with the third maximum amplitude value of 7, the third maximum amplitude value 7, and the pixel at coordinates (−1,0) has the pixel signal with the fourth maximum amplitude value of 6. For example, referring to FIG. 6, the image processing method may perform the first summing phase to generate a sum value of 23 by adding 15, which is an amplitude value of a center pixel as the maximum amplitude value, to 8, which is an amplitude value of a pixel at coordinates (1, 0) as the second maximum amplitude value. When the threshold sum value is set to 35, because the sum value of 23 is smaller than 35, the image processing method may proceed to the next summing phase. Thus, the image processing method may perform the second summing phase to generate a sum value of 30 by adding 7, which is an amplitude value of a pixel at coordinates (0, 1) as the third maximum amplitude value, to the sum value of 23. Because the sum value of 30 is smaller than 35, the image processing method may proceed to the next summing phase. Thus, the image processing method may perform the third summing phase to generate a sum value of 36 by adding 6, which is an amplitude value of a pixel at coordinates (−1, 0) as the fourth maximum amplitude value, to the sum value of 30. Because the sum value of 36 is greater than 35, the summing process may be terminated. The target amplitude values summed to generate the sum value of 36 are 15, 8, 7, and 6, and the target pixels respectively corresponding to the target amplitude values may be pixels at coordinates (0, 0), (1, 0), (0, 1), and (−1, 0). In another example, when the threshold sum value is set to 50, because a value obtained by adding the amplitude values of the signals of all the pixels of 3×3 of FIG. 6 does not reach 50, the image processing method may determine all the pixels of 3×3 as a target pixel.

Herein the threshold sum value may be a single value determined in advance or may be a variable according to the number of pixels to be processed. For example, when there is the signal-to-noise ratio necessary for the required precision of distance measurement, the image processing method may determine the above Str value as the threshold sum value. Accordingly, the threshold sum value may be a variable for the number of pixels to be processed. For example, when the required signal-to-noise ratio (S/N) is 6 and the dark noise (N) is 1, the Str being the sum amplitude value necessary to perform averaging processing on “n” pixels may be calculated like a graph of FIG. 7.

The image processing method may store a threshold sum value according to the number of pixels targeted for averaging processing in a memory in advance and may read a threshold sum value corresponding to the number of pixels to be processed. The image processing method may compare a sum amplitude value of pixels to be processed with the read threshold sum value, and thus, the image processing method may perform averaging processing as necessary for the required precision of distance measurement, without excess or deficiency.

At S550, the image processing method may calculate a distance value of the distance between the image sensing device and the object by performing averaging processing on the target pixels (e.g., the pixels at coordinates (0, 0), (1, 0), (0, 1), and (−1, 0) or all the pixels included in the pixel group) determined by using the above method.

As described above, assuming that the image sensing device emits the first modulation light and drives the two taps, charges of a pixel, which are generated by a reflected light of the first modulation light, may be distributed into the floating diffusion nodes of the two taps in synchronization with the driving of the two taps. Charge amounts of the distributed charges may be respectively referred to as “S0” and “S180”. Also, the image sensing device may emit the second modulation light obtained by shifting the emission timing of the first modulation light as much as ¼ a period; charge amounts obtained through the same method may be respectively referred to as “S90” and “S270”. A distance “D” to an object may be determined by using the charge amounts like Equation 6 below.

$$D = \frac{c}{2} \cdot \frac{1}{2 π F} Arctan ( \frac{S 0 - S 180}{S 90 - S 270} ) \qquad [ Equation 6 ]$$

Averaging processing may be performed in consideration of a method of performing averaging processing on pieces of distance data. As described above, because the light of the dot pattern has a profile, when averaging processing is simply performed on the distance value, a distance value of a pixel with a high signal-to-noise ratio may be affected by a distance value of a pixel with a low signal-to-noise ratio. In this case, the precision of distance measurement may not be improved. Accordingly, the image processing method according to an example embodiment of the disclosed technology may perform averaging processing by using charge amounts. In detail, assuming that five pixels are processed until a sum value obtained by summing amplitude values in descending order reaches the threshold sum value, a distance value Da after averaging processing may be calculated by Equation 7 below.

$$Da = \frac{c}{2} \cdot \frac{1}{2 π F} Arctan ( \frac{{\sum }_{n = 1}^{5} {( S 0 - S 180 )}_{n}}{{\sum }_{n = 1}^{5} {( S 90 - S 270 )}_{n}} ) \qquad [ Equation 7 ]$$

Herein, c may be the speed of light, and F may be a modulation frequency of a modulation light.

As described above, the image processing method may calculate the distance value by performing averaging processing by using the amounts of charges generated by the target pixels, and thus, the precision of distance measurement may be improved.

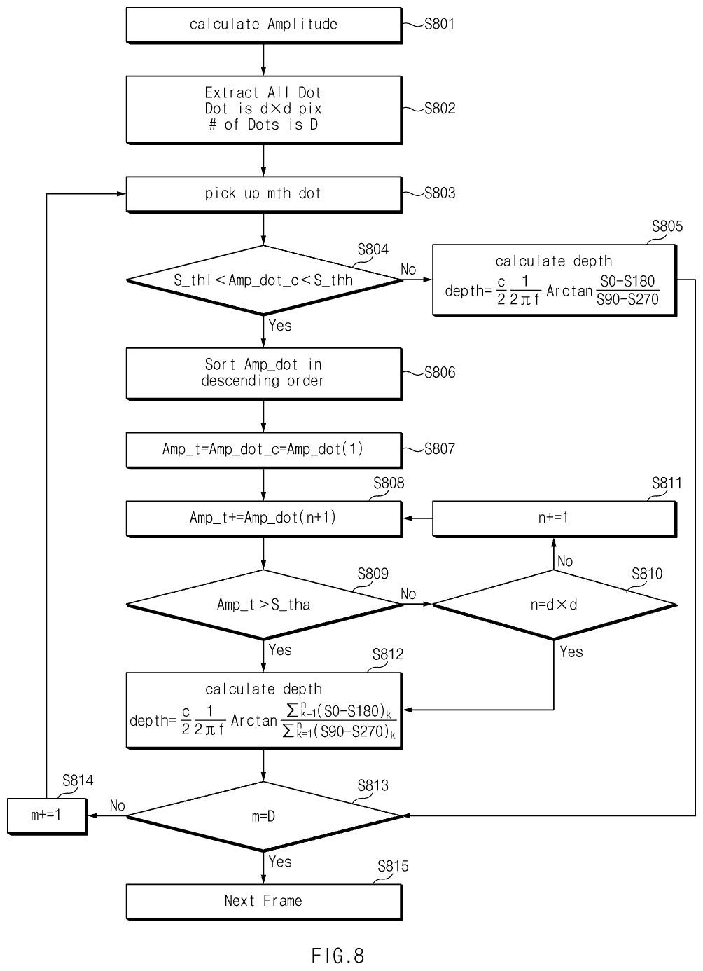

FIG. 8 is a flowchart illustrating an image processing method according to an example embodiment of the disclosed technology.

Referring to FIG. 8, at S801, an image processing method according to an example embodiment of the disclosed technology may calculate amplitude values of signals of pixels included in a pixel group corresponding to the dot pattern.

At S802, the image processing method may obtain data which are associated with the number of light of the dot pattern incident onto a pixel array, denoted as “D”, and a pixel group corresponding to the dot pattern, that is, data of a pixel group including pixels of d×d, onto which lights of one dot pattern are incident.

At S803, the image processing method may pick up an m-th pixel group among the detected “D” pixel groups.

At S804, the image processing method may determine whether the maximum amplitude value Amp_dot_c (i.e., an amplitude value corresponding to the center pixel in the pixel group) among the amplitude values of the signals of the pixels included in the pixel group corresponding to the dot pattern is greater than a first threshold amplitude value S_thl and is smaller than a second threshold amplitude value S_thh.

When the maximum amplitude value Amp_dot_c is smaller than the first threshold amplitude value S_thl or is greater than the second threshold amplitude value S_thh, at S805, the image processing method may calculate a distance value. In this case, the distance value may be calculated by Equation 6 above.

When the maximum amplitude value Amp_dot_c is greater than the first threshold amplitude value S_thl and is smaller than the second threshold amplitude value S_thh, at S806, the image processing method may sort the amplitude values of the signals of the pixels included in the pixel group in descending order.

At S807, the image processing method may set the maximum amplitude value Amp_dot_c being the first amplitude value Amp_dot(1) among the amplitude values sorted in descending order to an initial sum value Amp_t.

The image processing method may sum the amplitude values sorted in descending order one by one with the initial sum value Amp_t. For example, the image processing method may add the (n+1)-th amplitude value Amp_dot (n+1) among the amplitude values sorted in descending order to the initial sum value Amp_t.

At S809, the image processing method may determine whether the initial sum value Amp_t exceeds a threshold sum value S_tha.

When the initial sum value Amp_t does not exceed the threshold sum value S_tha, at S810, the image processing method may determine whether a value of “n” is equal to a value of d×d. In other words, when a value obtained by summing all the amplitude values of the signals of the pixels included in the pixel group fails to exceed the threshold sum value S_tha, the image processing method may perform step S810.

When the value of “n” is different from the value of d×d, that is, when the value of “n” is smaller than the value of d×d, at S811, the image processing method may add 1 to the value of “n” and may perform step S808.

When the initial sum value Amp_t exceeds the threshold sum value S_tha, at S812, the image processing method may calculate a distance value corresponding to the dot pattern by performing averaging processing on the pixels. In this case, the distance value may be calculated by Equation 7 above.

At S813, the image processing method may determine whether a value of “m” is equal to a value of “D”. According to the above description, the image processing method may perform image processing on lights of all the dot patterns irradiated on the pixel array.

When the value of “m” is different from the value of “D”, at S814, the image processing method may add 1 to the value of “m” and may perform step S803.

When the value of “m” is equal to the value of “D,” at S815, the image processing method may perform image processing on a next frame.

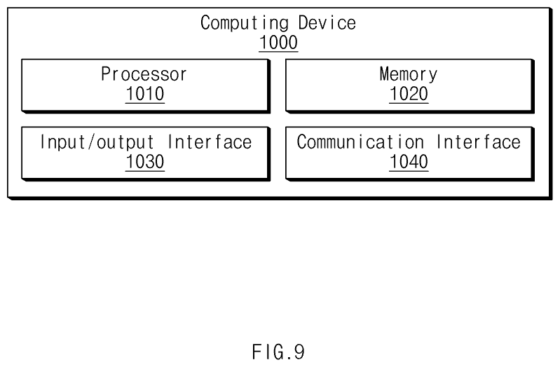

FIG. 9 is a block diagram illustrating an example of a computing device corresponding to an image processing device of FIG. 1.

Referring to FIG. 9, a computing device 1000 may show an embodiment of a hardware configuration for performing the operation of the image processing device 200 of FIG. 1.

The computing device 1000 may be mounted on a chip independent of a chip on which an image sensing device is mounted. According to an embodiment, the chip on which the image sensing device is mounted and the chip on which the computing device 1000 is mounted may be implemented with a single package, for example, a multi-chip package (MCP), but the scope of the disclosed technology is not limited thereto.

The computing device 1000 may include a processor 1010, a memory 1020, an input/output interface 1030, and a communication interface 1040.

The processor 1010 may process data and/or an instruction necessary to perform the operations of the components of the image processing device 200 described with reference to FIG. 1.

The memory 1020 may store the data and/or the instruction necessary to perform the operations of the components of the image processing device 200 and may be accessed by the processor 1010. For example, the memory 1020 may be implemented with a volatile memory (e.g., a DRAM (Dynamic Random Access Memory) or an SRAM (Static Random Access Memory)) or a nonvolatile memory (e.g., a PROM (Programmable Read Only Memory), an EPROM (Erasable PROM), an EEPROM (Electrically Erasable PROM), or a flash memory).

That is, as a computer program for performing the operation of the image processing device 200 disclosed in the specification is recorded at the memory 1020 and is executed and processed by the processor 1010, the operations of the image processing device 200 may be implemented.

The input/output interface 1030 may provide an interface which connects the processor 1010 with an external input device (e.g., a keyboard, a mouse, or a touch panel) and/or an external output device (e.g., a display) such that data are transmitted/received.

The communication interface 1040 which is a component capable of exchanging various kinds of data with an external device (e.g., an application processor or an external memory) may be a device capable of supporting wired or wireless communication.

An image processing device according to an example embodiment of the disclosed technology may perform averaging processing on pixels corresponding to a dot pattern.

The image processing device according to an example embodiment of the disclosed technology may determine whether to perform averaging processing on the pixels, depending on whether the precision of distance measurement is improved.

The image processing device according to an example embodiment of the disclosed technology may perform averaging processing on at least some of the pixels by determining pixels targeted for averaging processing.

The image processing device according to an example embodiment of the disclosed technology may determine whether to perform averaging processing by using a signal-to-noise ratio.

The image processing device according to an example embodiment of the disclosed technology may determine target pixels, on which averaging processing will be performed, by using a signal-to-noise ratio.

It will be appreciated by one skilled in the art that the effects capable of being achieved with the disclosed technology are not limited to what has been particularly described hereinabove and other advantages of the disclosed technology will be more clearly understood from the detailed description taken in conjunction with the accompanying drawings.

Hereinabove, although the disclosed technology has been described with reference to exemplary embodiments and the accompanying drawings, the disclosed technology is not limited thereto, but may be variously modified and altered by those skilled in the art to which the disclosed technology pertains without departing from what has been described in this patent document.

What is claimed is:

1. An image processing device, comprising:
a determination unit configured to i) determine, for a pixel group including pixels in an pixel array of an imaging device that receives reflected light from an object carrying a dot pattern, whether to perform an averaging processing on at least some of the pixels included in the pixel group corresponding to the dot pattern, based on a maximum amplitude value among amplitude values of pixel signals of the pixels, and ii) determine target pixels from among the pixels, based on a result of summing at least some of the amplitude values of pixel signals of the pixels in the pixel group; and
a calculation unit in communication with the determination unit and configured to perform an averaging processing on pixel signals of the target pixels to calculate a distance value of a distance between the imaging device and the object corresponding to the dot pattern.

2. The image processing device of claim 1, wherein the determination unit is configured to determine to perform the averaging processing, in response to the maximum amplitude value being greater than a first threshold amplitude value and smaller than a second threshold amplitude value.

3. The image processing device of claim 2, wherein the determination unit is configured to determine the first threshold amplitude value by using a first sum amplitude value necessary to perform the averaging processing on all the pixels and a second sum amplitude value obtained by normalizing and summing the amplitude values of the pixel signals.

4. The image processing device of claim 2, wherein the determination unit is configured to determine an amplitude value required to calculate the distance value by using one of the pixels of the pixel group, as the second threshold amplitude value.

5. The image processing device of claim 2, wherein the determination unit is configured to determine the first threshold amplitude value and the second threshold amplitude value based on using a dark noise and a signal-to-noise ratio.

6. The image processing device of claim 1, wherein the determination unit is configured to determine the target pixels by performing multiple summing phases summing the amplitude values one by one in descending order from maximum to minimum amplitude values and comparing a sum value calculated in each summing phase with a threshold sum value.

7. The image processing device of claim 6, wherein the determination unit is configured to determine, as the target pixels, pixels corresponding to target amplitude values summed until the calculated sum value is greater than or equal to the threshold sum value.

8. The image processing device of claim 7, wherein the determination unit is configured to determine all the pixels included in the pixel group as the target pixels, in response to a value obtained by adding all the amplitude values of the pixel signals included in the pixel group being smaller than the threshold sum value.

9. The image processing device of claim 6, wherein the determination unit is configured to determine the threshold sum value so as to have different values depending on the number of the target amplitude values summed in the each summing phase.

10. The image processing device of claim 6, wherein the determination unit is configured to determine the threshold sum value based on a dark noise and a signal-to-noise ratio.

11. The image processing device of claim 1, wherein the determination unit is configured to further determine the pixel group such that an amplitude value of a center pixel of the pixel group is the maximum amplitude value.

12. The image processing device of claim 1, wherein the calculation unit is configured to calculate the distance value by performing the averaging processing based on amounts of charges generated by the target pixels.

13. An image processing device comprising:
a determination unit configured to perform summing amplitude values of pixel signals of pixels included in a pixel group of an imaging device that directs light carrying a dot pattern to an object and receives reflected light from the object, the summing of the amplitude values including multiple summing phases to sum the pixel signals one by one in descending order and to determine target pixels, on which an averaging processing is to be performed, from among the pixels based on the sum value; and
a calculation unit configured to calculate a distance value of a distance between the imaging device and the object corresponding to the dot pattern by performing the averaging processing on the target pixels.

14. The image processing device of claim 13, wherein the determination unit is configured to:
determine whether to perform the averaging processing on at least some of the pixels, based on a maximum amplitude value among the amplitude values; and
determine the target pixels, based on determining to perform the averaging processing.

15. The image processing device of claim 14, wherein the determination unit is configured to determine to perform the averaging processing, in response to the maximum amplitude value being greater than a first threshold amplitude value and smaller than a second threshold amplitude value.

16. The image processing device of claim 15, wherein the determination unit is configured to determine the first threshold amplitude value by using a first sum amplitude value to perform the averaging processing on all the pixels and a second sum amplitude value obtained by normalizing and summing the amplitude values of the signals of the pixels.

17. The image processing device of claim 15, wherein the determination unit is configured to determine an amplitude value required to calculate the distance value by using one of the pixels of the pixel group, as the second threshold amplitude value.

18. The image processing device of claim 13, wherein the determination unit is configured to determine, as the target pixels, pixels corresponding to target amplitude values summed until the sum value is greater than or equal to a threshold sum value.

19. The image processing device of claim 18, wherein the determination unit is configured to determine all the pixels included in the pixel group as the target pixels, in response to a value obtained by adding all the amplitude values being smaller than the threshold sum value.

20. An image processing method, comprising:
determining target pixels, on which averaging processing is to be performed, from among pixels included in a pixel group corresponding to a dot pattern, based on a result of summing at least some of amplitude values of pixel signals of the pixels; and
calculating a distance value corresponding to the dot pattern by performing the averaging processing by using amounts of charges generated by the target pixels.

21. The image processing method of claim 20, wherein the summing is obtained by performing summing of the amplitude values of the pixel signals one by one in descending order.
